(19) United States
(12) Patent Application Publication
(10) Pub. No.: US 2011/0116491 A1
(43) Pub. Date: May 19, 2011

(54) IMPROVING TRANSMISSION OF MEDIA STREAMS OF BROADCAST SERVICES IN A MULTIMEDIA BROADCAST TRANSMISSION SYSTEM

(76) Inventors: Akos Kovacs, Budapest (HU); Istvan Godor, Budapest (HU)

(21) Appl. No.: 13/000,839

(22) PCT Filed: Jun. 23, 2008
(86) PCT No.: PCT/EP08/57951

§ 371 Date: Dec. 22, 2010

(51) Int. Cl. H04J 3/00

(52) U.S. Cl. 370/345

(57) ABSTRACT

In multimedia broadcast transmission a system a method and a device for improving transmission are provided. The optimization is achieved by the combination of a Virtual Time-Slice (VTS) solution within a broadcast service in which time-slice corresponding to a layered broadcast service and a feedback channel through a wireless access network. The VTS allows the system to set the layer content within a broadcast service time-slice according to the user's feedbacks. An optimization algorithm selects the appropriate number of enhancement layers mapped into VTSs. The users provide feedback information based on their own receiving capabilities or on subscription limitations. If a time-division multiplex multimedia broadcast network, e.g. DVB-H network is deployed next to the wireless access network, e.g. a 3G network, then these feedback information can be signaled via this network.

### TECHNICAL FIELD

The invention relates in general to a multimedia broadcast transmission system. In particular, the present invention directed to a system a method and a device for a time-division multiplex multimedia broadcast transmission.

### BACKGROUND

Multimedia broadcast/multicast services are widely spread, especially since mobile handheld devices became capable to receive multimedia content via radio networks. Services like Mobile TV, gives the opportunity to watch a program in an interactive way on for example, a mobile phone or a Personal Digital Assistant (PDA). However, delivering multimedia over a wireless channel raises some concern. Subscribers may experience different channel quality while receiving the same content. In addition, each user wants the highest possible quality of the media. Furthermore, handheld devices have strict power. Service providers and delivery technologies have to cope with these problems. Layered and scalable codecs have developed to enable the transport network to adapt the multicast/broadcast stream to changing network conditions. The higher the number of the received layers is, the better the user-perceived quality becomes at the expense of the used bandwidth for the transmitted stream. By transmitting the correct (sub)set of media layers based on the knowledge of user-demands the channel-reservation time may become lower. DVB-H is a standard that aims to provide a time-division multiplex multimedia broadcast solution for handheld devices. However, the adaptation of multimedia flows has to be supported by delivery technologies and access networks in order to cope with the other main challenge: the heterogeneity of receivers.

DVB-H technology is a superset of the very successful DVB-T (Digital Video Broadcasting-Terrestrial) system for digital terrestrial television, with additional features to meet the specific requirements of handheld, battery-powered receivers. DVB-H can offer a downstream channel at high data rates which can be used as standalone or as an enhancement of mobile telecommunication networks which many typical handheld terminals are able to access anyway.

A special problem for DVB-H terminals is the limited battery capacity. In a way, being compatible with DVB-T would place a burden on the DVB-H terminal because demodulating and decoding a broadband, high data-rate stream like the DVB-T stream involves certain power dissipation in the tuner and the demodulator part. A considerable drawback for battery-operated terminals is the fact that with DVB-T, the whole data stream has to be decoded before any one of the broadcast services (TV programs) of the multiplex can be accessed. The power saving made possible by DVB-H is derived from the fact that essentially only those parts of the stream which carry the data of the broadcast service currently selected have to be processed. However, the data stream needs to be reorganized in a suitable way for that purpose. With DVB-H, broadcast service multiplexing is performed in time-division multiplex. The data of one particular broadcast service are therefore not transmitted continuously but in compact periodical bursts with interruptions in between. Multiplexing of several broadcast services leads again to a continuous, uninterrupted transmitted stream of constant data-rate. This kind of signal can be received time-selectively: the terminal synchronizes to the bursts of the wanted broadcast service but switches to a power-save mode during the intermediate time when other broadcast services are being transmitted. The power-save time between bursts, relative to the on-time required for the reception of an individual broadcast service, is a direct measure of the power saving provided by DVB-H. This technique is called time slicing. Bursts entering the receiver have to be buffered and read out of the buffer at the broadcast service data-rate. The amount of data contained in one burst needs to be sufficient for bridging the power-save period of the front end. The position of the bursts is signaled in terms of the relative time difference between two consecutive bursts of the same broadcast service. Practically, the duration of one burst is in the range of several hundred milliseconds whereas the power-save time may amount to some seconds. A lead time for powering up the front end (e.g., for resynchronization, etc.) has to be taken into account; this time period is assumed to be less than 250 ms. Depending on the ratio of on-time/power-save time, the resulting power saving may be more than 90%.

Additionally, time slicing allows soft handover if the receiver moves from network cell to network cell with only one receiver unit. For reliable transmission in poor signal reception conditions, an enhanced error-protection scheme on the link layer is introduced. This scheme is called MPE-FEC (Multi-Protocol Encapsulation-Forward Error Correction). MPE-FEC employs powerful channel coding on top of the channel coding included in the DVB-T specification and offers a degree of time interleaving. Furthermore, the DVB-H standard features an additional network mode, the 4K mode, offering additional flexibility in designing Single Frequency Networks (SFNs) which still are well suited for mobile reception, and also provides an enhanced signaling channel for improving access to the various broadcast services.

Existing methods separate the program channels of DVB-H as follows. For programs requiring more bandwidth, the system provides more time slices over time. This concept helps the system to “protect” streams with higher bandwidth requirements and to let more parallel transmissions. This solution also saves power for streams with lower data rate. However, the method does not take into account the heterogeneity of users. That is, it cannot differentiate between users experiencing different channel quality, having different display sized devices etc.

There is a widespread knowledge about this kind of technology, the most relevant examples of which are as follows:

In WO/2006/125850 a method and apparatus is provided for transmitting, and a method and apparatus for receiving a digital broadcast signal comprising a hierarchical modulation having a high priority multimedia stream and a low priority multimedia stream. Each multimedia stream may contain one or more media streams of a particular coding type as well as associated signaling. At least one source of media content to be received or transmitted is encoded into two streams so that a first stream is configured to be transmitted or received with the high priority stream, and a second stream to be transmitted or received with the low priority stream is configured to contain additional information for increasing the bitrate of the first stream. The low and high priority streams are separate IP streams and DVB signals, though they belongs to the same media stream. The sub-streams are distributed by IP prioritization.

This method however does not consider the receiving capabilities of the subscribed end-user terminals, that is, the described method is similar to and can be taken as an adaptation of one of the well-known multicast control protocols, e.g., the RLC. The layers of a common stream, that is the separate IP multicast groups are mapped to DVB signals within the given broadcast service. Furthermore, the method is rather static; it transmits high priority data even in those cases when no receivers are able to receive that data. This is, because the method does not consider the capabilities of receivers.

In WO 2005/065155 an apparatus and a method for adaptive broadcast transmission are described. After receiving insufficiency of a broadcast channel a negative acknowledgement signal is sent on a common uplink channel in response to the insufficient quality. As a consequence the broadcast channel quality can be adjusted in response to the negative acknowledgement signal.

In this method an adaptive transmission is established however by using a common uplink channel, the service provider is unable to differentiate among users in order to offer them different levels of feedback capabilities.

### SUMMARY

The object of this invention to improve the transmission in a multimedia broadcast transmission system.

The present invention involves a system a method and a device, which solves at least some of the aforementioned problems, as well as other problems that will become apparent from an understanding of the following description.

One aspect of the invention is a method that combines a technique of Virtual Time-Slices (VTSs) with capability of a wireless access network deployed next to a time-division multiplex multimedia broadcast network.

On one hand, a device in the time-division multiplex multimedia broadcast network collects feedback information of the users over the wireless access network, and defines, compiles and transmits VTSs provided within the time-slices of a media streams of a broadcast service carrying media layers over a broadcast radio channel of the time-division multiplex multimedia broadcast network to terminals of the users.

On the other hand, the terminals send the feedback information of the users over the wireless access network to the device providing a connection to the time-division multiplex multimedia broadcast network, and receives the streams of the VTSs over the broadcast radio channel of the time-division multiplex multimedia broadcast network.

Another aspect of the invention is a device in a time-division multiplex multimedia broadcast network, in which the broadcast services are organized into time-slices carrying layers of the media streams and broadcasted over the time-division multiplex multimedia broadcast network. In order to collect feedback information of users the device comprises a feedback aggregator and a VTS generator. In the VTS generator a VTS definer logic defines the number of VTSs provided within time-slices, a compiler compiles the number of VTSs, and a transmitter transmits the VTSs of the media stream to terminals of the users.

A further aspect of the invention is a terminal of a user in a time-division multiplex multimedia broadcast network in which the terminal receives media streams of broadcast services of the time-division multiplex multimedia broadcast network communicates over a wireless access network. The terminal comprises a receiver and a transmitter. The receiver receives the media streams of the VTSs over the broadcast radio channel of the time-division multiplex multimedia broadcast network, and the transmitter sends feedback information of the user to the device of the time-division multiplex multimedia broadcast network over the wireless access network.

In preferred embodiments, the feedback information can be received over a secure channel and may be input data based on information of receiving capabilities of the terminal, e.g. information on initial display constrains of the terminal. The feedback information of the users may relate to information of subscription limitations or information of an enhanced error protection. In the latter case Feedback information also may comprise input data based on channel quality measurements of the users.

Practically, the time-division multiplex multimedia broadcast network can be a Digital Video Broadcast-Handheld network, and the wireless access network can be a 3G network.

There are several advantages of the present invention stemming from avoiding transmission of unnecessary layers of media streams:

Due to the optimization, the terminal saves more power for layered media broadcast.

A further benefit comes from the VTSs that require smaller playout buffer deployed at the terminal releasing additional capabilities for broadcast services.

It is also advantageous that the secured media transmission allows each user to receive only that quality which is determined in his/her broadcast service subscription.

A further advantage is the possibility of unequal error protection accruing from the personalized quality of the users.

### BRIEF DESCRIPTION OF THE DRAWINGS

For a more complete understanding of the invention, reference is made to the following detailed description of alternatives taken in conjunction with the accompanying drawings wherein:

FIG. 1 schematically illustrates a system model for improving user-perceived quality according to an embodiment of the present invention.

FIGS. 2A and 2B are schematic flowcharts for illustrating method steps performed in embodiments of the present invention.

FIG. 3 is a schematic block diagram illustrating a device embodying the present invention.

FIG. 4 is an implementation of the Virtual Time-Slicing.

### DETAILED DESCRIPTION

For a better understanding, the following definition of the following terms are provided.

Media streams: Flow of media distributed over telecommunications networks that is constantly received by, and normally displayed to, the user while it is being delivered by the provider, preferable data flow of radio or television programs.
Broadcast services: services, preferable radio, TV or Video-on-Demand contents transmitted by broadcast technology.
Time-division multiplex multimedia broadcast network: a broadcast network capable of transmitting multimedia content, using time-division multiplexing, preferable a Digital Video Broadcast-Handheld (DVB-H) network.
Time-slices: time slots carrying data bursts of broadcast services.
Virtual Time-Slices: Further parts of a time-slice carrying layers of the media stream, preferable of equal size.
Layers (media layers): Fragments of a single media stream. Consist of at least one base layer and some enhancement layers. The base layer is necessary for the media stream to be decoded, enhancement layers are applied to improve media stream quality.
Feedback information: information coming from users, containing information, preferable receiving capabilities of the terminals, or subscription limitations, or error protection.
Wireless access network: a telecommunications network in which the access of the users is implemented without the use of wires, preferable a 3G network.
Broadcast radio channel: A radio channel carrying broadcast services preferable TV or radio programs, Video on Demand, etc.
Terminal: A handheld device of the user furnished with both telecommunications and receiver capabilities of broadcast services, preferable a 3G telephone with DVB-H receiver.
Secured feedback channel: A channel dedicated to a user carrying feedback information, preferable a secured point-to-point connection between the service provider and each user.

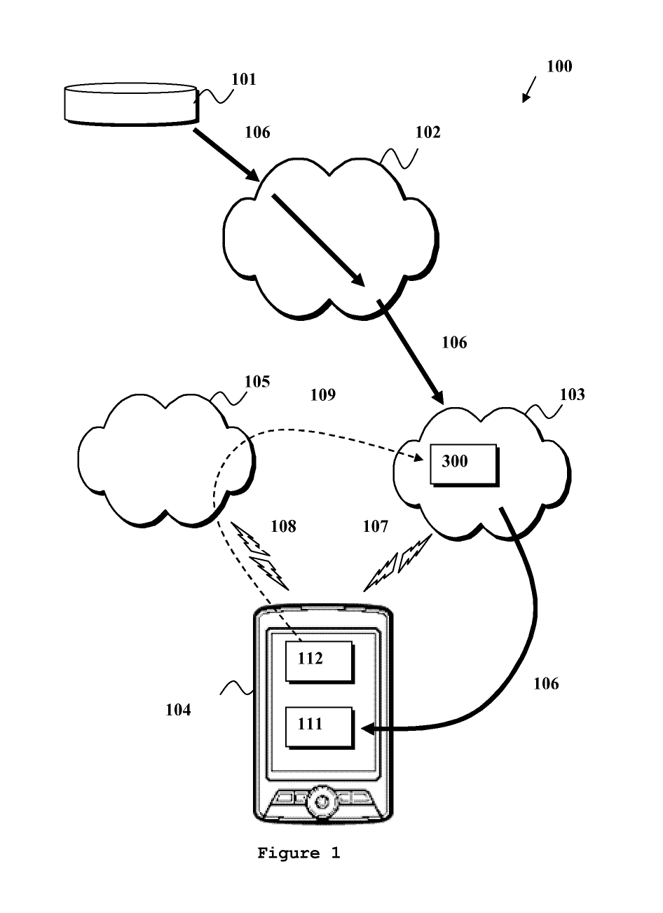

A multimedia broadcast transmission system 100 can be seen in FIG. 1. A content provider 101 broadcasts media streams of broadcast services 106 that carry services like TV, Video-on-Demand, through a core network 102 and a time-division multiplex multimedia broadcast network 103 to a terminal 104 of a user. In this embodiment the time-division multiplex multimedia broadcast network 103 is a Digital Video Broadcast-Handheld (DVB-H) network. A wireless access network 105 is also provided next to the time-division multiplex multimedia broadcast network 103. The terminal 104 have separate radio channels 107, 108 to both the time-division multiplex multimedia broadcast network 103 and to the wireless access network 105 that can be a 3G network preferably. A feedback channel 109 is established from the terminal 104 through the wireless access network 105 to the time-division multiplex multimedia broadcast network 103. In an advantageous embodiment, the feedback channel 109 is a secure channel providing personalized broadcast service for individual users. The terminal 104 comprises a broadcast receiver 111 adapted to receive the media streams of broadcast services 106 over the broadcast radio channel 107 of the time-division multiplex multimedia broadcast network 103, and a point-to-point wireless data communication transmitter 112 adapted to send feedback information of the user to a device 300 of the time-division multiplex multimedia broadcast network 103 over the wireless access network 105.

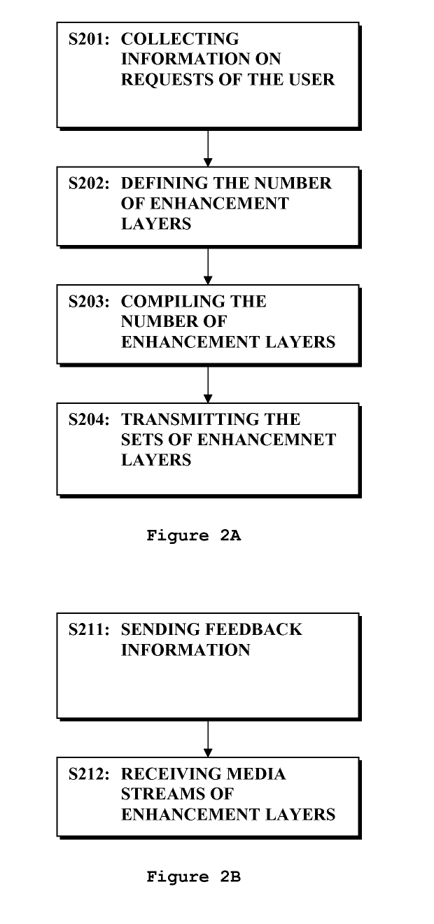

The process of improved transmission is summarized in FIGS. 2A and 2B. FIG. 2A shows the steps implemented in the device 300 of the time-division multiplex multimedia broadcast network 103. In the first step S201 the device 300 of the time-division multiplex multimedia broadcast network 103 periodically collects feedback information of the users. The information can be e.g. receiving capabilities of the terminal 104 (initial display constraints) or subscription limitation of the user. In another case this feedback information may comprise input data based on channel quality measurements of the users. This input is transmitted through the feedback channel 109. The broadcast service can be interactive and the interactive feedback channel 109 uses the wireless access network 105.

In the next step S202 an optimization algorithm defines Virtual Time-Slices provided within the time-slices carrying media layers and compiles S203 them. The number of enhancement layers is the function of the information collected from the users and provides an improved transmission which will be apparent in the followings.

In the next step S204, the device 300 transmits the Virtual Time-Slices over the broadcast radio channel 107 of the time-division multiplex multimedia broadcast network 103 to terminals 104 of the users.

The receiving capabilities of the terminal 104 depends on different factors, e.g. initial display constraints of the terminal 104, subscription limitations by the service provider 101 or periodical channel quality measurements. In case of subscriber limitation, the service provider 101 is able to differentiate among users in order to offer them different levels of feedback capabilities if the feedback channel 109 is a secure channel.

FIG. 2B shows the steps implemented in the terminal 104. In the first step S211 the terminal 104 sends feedback information identical to the information collected by the device 300 of the time-division multiplex multimedia broadcast network 103 mentioned in FIG. 2A. On the other hand the terminal 104 receives S212 the media streams of Virtual Time-Slices provided within the time-slices over the broadcast radio channel 107 of the time-division multiplex multimedia broadcast network 103.

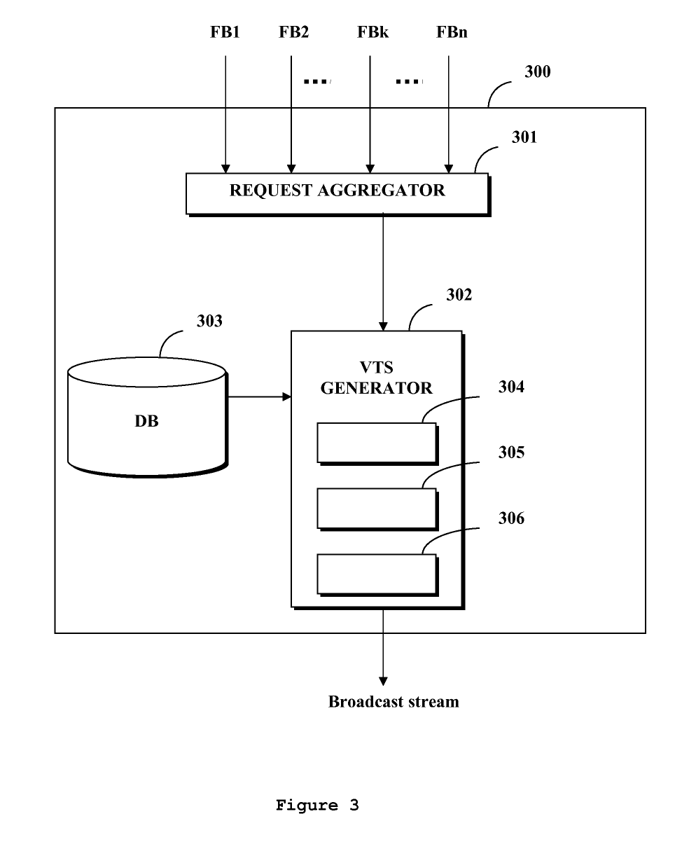

FIG. 3 shows a possible embodiment of the device 300 implementing the method described above. In the present embodiment, the device 300 is implemented in a node of the time-division multiplex multimedia broadcast network 103. A request aggregator 301 collects feedback information FB1, FB2, . . . , FBk, . . . , FBn of the users and forwards them to a Virtual Time-Slice generator 302 in which the number of Virtual Time-Slices is defined. The Virtual Time-Slice generator 302 comprises a Virtual Time-Slice definer logic 304 adapted to define the number of Virtual Time-Slices provided within time-slices, a compiler 305 adapted to compile the number of Virtual Time-Slices carrying media layers according to the feedback information FB1, FB2, . . . , FBn of users, and a transmitter 306 adapted to transmit the Virtual Time-Slices of the media stream to terminals 104 of the users.

In a database 303, connected to the Virtual Time-Slice generator 302, user specific information is stored for the compilation of Virtual Time-Slices. Preferable user specific information can relate to receiving capabilities of the terminal 104 or to subscription limitation based on agreement with the service provider 101. This agreement contains quality limitations for the user subscribed for the broadcast service. The database 303 can store also the keys for secured media transmission. Each user can request and receive only that quality which is determined in his/her service subscription. The distribution of the decryption keys (requiring point-to-point communication) can be done through the wireless access network 105. The Virtual Time-Slice generator 302 forwards media streams of broadcast services in its output to the terminals 104 of the users.

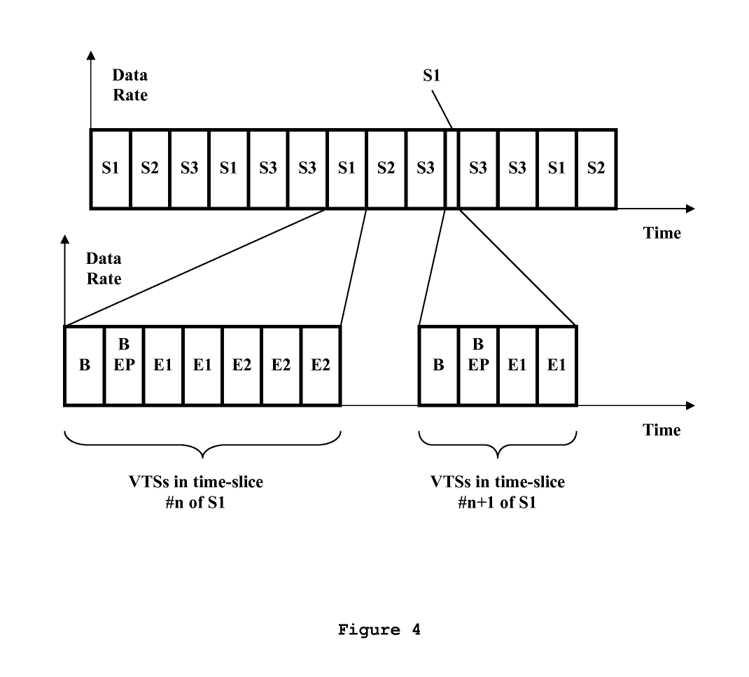

FIG. 4 shows a possible bitmap explaining the relation between time-slices S1, S2, S3 and Virtual Time-Slices (VTSs). In the figure, S1, S2, S3 denote time-slices of broadcast services transmitted by a time-division multiplex multimedia broadcast network, preferable by a DVB-H network. For example, a particular broadcast service transmitted in the time-slice denoted by S1 delivers a layered media comprising a set of layers to be broadcasted. These layers are mapped to Virtual Time-Slices of equal size, preferably. According to the figure, the broadcast service transmitted in time-slice S1 consists of a base B, and two enhancement layers E1 and E2. Since layer E2 requires the most bandwidth, it gets the most number (three) of VTSs. Altogether, the total number of VTSs in time-slice #n is seven. Between the time-slice of #n and #n+1 the system is informed that there is no need to transmit the highest enhancement layer E2, e.g., because the receiver with the largest display has left the broadcast service; or the channel condition does not allow such high bandwidth. The optimization algorithm re-define the layer set of the VTSs, and sends data in the next time-slice #n+1 for broadcast service transmitted in time-slice S1 according to it. Since the new length of the time-slice S1 is shorter, a less number of VTSs is needed. According to the example, slice S1 of #n+1 consists of two base B and two enhancement layers E1, that can be mapped to only a number of four VTSs. This way, the terminal can save extra power during the media session by sparing the transmission of enhancement layers denoted by E2. Furthermore, the layers belonging together can be decoded at the same time, right after the end of the time-slice, i.e. the terminal do not have to wait for the next media layer required by the decoder till the next time-slice. In that case, smaller playout buffer is required, because the layered/scalable media uses inter-layer prediction.

Another way, how the system can profit of VTS is an enhanced error protection that can be applied for more important parts of the media. For example, such important part can be the base layer B. That is, more VTSs can be allocated for the base layer B. In these extra VTSs the protection part is transmitted, which can be, e.g., duplication of the protected layer or data of other applicable error correction schemes. This way, Unequal Error Protection (UEP) can be applied for the transmitted media stream.
Another benefit of the invention can be the subscription limitation that may require encrypting the media layers. In that case, each user is able to decode only those layers to which the user has permission. The decodable media layers explicitly determine the perceived quality that the user can receive according to the subscription limitation.
In case of encrypted media transmission, all layers have a corresponding decryption key. The appropriate keys should be sent to each user. The key distribution can be done through a secured point-to-point channel dedicated between the service provider and each user. For this purpose, e.g., a 3G connection can be used without any modification of the DVB-H standard.

Although preferred embodiments of the present invention have been illustrated in the accompanying drawings and described in the foregoing detailed description, it is understood that the invention is not limited to embodiments disclosed for Digital Video Broadcast-Handheld (DVB-H) transmission system, but is capable of numerous rearrangements, modifications, and substitutions for a multimedia broadcast transmission system based on VTSs within the existing time-slices combined with a feedback channel, as realized and defined by the following claims.

1. A method for improving transmission of media streams of broadcast services (106) in a device (300) of a time-division multiplex multimedia broadcast network (103), in which the broadcast services are organized into time-slices carrying layers of the media streams and broadcasted over the time-division multiplex multimedia broadcast network (103), characterized in that the method further comprises the steps of
collecting (S201) feedback information (FB1, FB2, . . . , FBn) of users over a wireless access network (105),
defining (S202) Virtual Time-Slices provided within the time-slices carrying media layers
compiling (S203) the number of Virtual Time-Slices according to the feedback information (FB1, FB2, . . . , FBn) of the users and
transmitting (S204) the Virtual Time-Slices over a broadcast radio channel (107) of the time-division multiplex multimedia broadcast network (103) to terminals (104) of the users.

2. The method of claim 1, in which the feedback information (FB1, FB2, . . . , FBn) is received over a secured feedback channel (109) of the wireless access network (105).

3. The method of claim 1, in which the feedback information (FB1, FB2, . . . , FBn) of the users comprises information of receiving capabilities of the terminals (104).

4. The method of claim 3, in which receiving capabilities comprises information on initial display constrains of the terminals (104).

5. The method of claim 1, in which the feedback information (FB1, FB2, . . . , FBn) of the users comprises information of subscription limitations.

6. The method of claim 1, in which the feedback information (FB1, FB2, . . . , FBn) of the users comprises information of an enhanced error protection.

7. The method of claim, 1 in which the feedback information (FB1, FB2, . . . , FBn) is based on channel quality measurements of the users.

8. The method of claim, 1 in which the time-division multiplex multimedia broadcast network (103) is a Digital Video Broadcast-Handheld network.

9. The method of claim 1, in which the wireless access network (105) is a 3G network.

10. A method for improving transmission of media streams of broadcast services in a terminal (104) provided with a point-to-point wireless data communication transmitter (112) and a broadcast receiver (111) for receiving the media streams of broadcast services, in which the broadcast services are organized into time-slices and broadcasted over a time-division multiplex multimedia broadcast network (103) to the terminal (104), characterized in that the method further comprises the steps of
sending (S211) feedback information (FB1, FB2, . . . , FBn) of the users over a wireless access network (105) to a device (300) providing a connection to the time-division multiplex multimedia broadcast network (103), and
receiving (S212) streams of Virtual Time-Slices provided within the time-slices over a broadcast radio channel (107) of the time-division multiplex multimedia broadcast network (103).

11. The method of claim 10, in which the feedback information (FB1, FB2, . . . , FBn) is received over a secured feedback channel (109) of the wireless access network (105).

12. The method of claim 10, in which the feedback information (FB1, FB2, . . . , FBn) of the users comprises information of receiving capabilities of the terminals (104).

13. The method of claim 12, in which receiving capabilities comprises information on initial display constrains of the terminals (104).

14. The method of claim 10, in which the feedback information (FB1, FB2, . . . , FBn) of the users comprises information of subscription limitations.

15. The method of claim 10, in which the feedback information (FB1, FB2, . . . , FBn) of the users comprises information of an enhanced error protection.

16. The method of claim, 10 in which the feedback information (FB1, FB2, . . . , FBn) is based on channel quality measurements of the users.

17. The method of claim, 10 in which the time-division multiplex multimedia broadcast network (103) is a Digital Video Broadcast-Handheld network.

18. The method of claim 10, in which the wireless access network (105) is a 3G network.

19. A terminal (104) of a user in a time-division multiplex multimedia broadcast network (103), the terminal (104) is adapted to receive media streams of broadcast services (106) of the time-division multiplex multimedia broadcast network (103), and the terminal (104) is also adapted to communicate over a wireless access network (105), characterized in that the terminal comprises
a receiver (111) adapted to receive the media streams of Virtual Time-Slices provided within the time-slices over a broadcast radio channel (107) of the time-division multiplex multimedia broadcast network (103), and
a transmitter (112) adapted to send feedback information (FBk) of the user to a device (300) of the time-division multiplex multimedia broadcast network (103) over a wireless access network (105).

20. The terminal of claim 19, in which the feedback information (FBk) is sent over a secured feedback channel (109) of the wireless access network (105).

21. The terminal (104) of claim 19, in which the feedback information (FBk) of the user comprises information of receiving capabilities of the terminal (104).

22. The terminal (104) of claim 21, in which receiving capabilities of the terminal (104) comprises information on initial display constrains of the terminal (104).

23. The terminal (104) of claim 21, in which the feedback information (FBk) of the user comprises information of subscription limitations.

24. The terminal (104) of claim 21, in which the feedback information (FBk) of the user comprises information of an enhanced error protection.

25. The terminal (104) of claim 19, in which the feedback information (FBk) comprises input data based on channel quality measurements of the user.

26. The terminal (104) of claim 19, in which the time-division multiplex multimedia broadcast network (103) is a Digital Video Broadcast-Handheld network.

27. The terminal (104) of claim 19, in which the wireless access network (105) is a 3G network.

28. A device (300) in a time-division multiplex multimedia broadcast network (103), in which the broadcast services are organized into time-slices carrying layers of the media streams and broadcasted over the time-division multiplex multimedia broadcast network (103), characterized in that the device (300) comprises
a feedback aggregator (301) adapted to collect feedback information (FB1, FB2, . . . , FBn) of users over a wireless access network (105),
a Virtual Time-Slice generator (302) having
a) a Virtual Time-Slice definer logic (304) adapted to define the number of Virtual Time-Slices provided within time-slices,
b) a compiler (305) adapted to compile the number of
Virtual Time-Slices carrying media layers according to the feedback information (FB1, FB2, . . . , FBn) of users, and
c) a transmitter (306) adapted to transmit the Virtual Time-Slices of the media stream to terminals (104) of the users.

29. The device (300) of claim 1, in which the feedback information (FB1, FB2, . . . , FBn) is received over a secured feedback channel (109) of the wireless access network (105).

30. The device (300) of claim 28, in which the feedback information (FB1, FB2, . . . , FBn) of the users relates to receiving capabilities of the terminal (104).

31. The device (300) of claim 28, in which the feedback information (FB1, FB2, . . . , FBn) of the users relates to subscription limitations.

32. The device (300) of claim 28, in which the feedback information (FB1, FB2, . . . , FBn) of the users relates to requests of decryption keys for secure media transmission.

33. The device (300) of claim 28, in which a database (303) adapted to store information on the users is connected to the Virtual Time-Slice generator (302).
